(19) United States
(12) Patent Application Publication
(10) Pub. No.: US 2010/0220016 A1
(43) Pub. Date: Sep. 2, 2010

(54) Multiband Antenna System And Methods

(76) Inventors: Pertti Nissinen, Kempele (FI); Antti Leskelä, Oulu (FI); Jari Perunka, Tupos (FI); Zlatoljub Milosavljevic, Kempele (FI); Petteri Annamaa, Oulunsalo (FI); Kimmo Koskiniemi, Oulu (FI)

Correspondence Address: GAZDZINSKI & ASSOCIATES, PC, 16644 WEST BERNARDO DRIVE, SUITE 201, SAN DIEGO, CA, 92127, US

(21) Appl. No.: 12/083,129

(22) PCT Filed: Sep. 20, 2006
(86) PCT No.: PCT/FI2006/050403

§ 371 Date: May 17, 2010

(30) Foreign Application Priority Data
Oct. 6, 2005 (FI) 20055539

(51) Int. Cl. H01Q 9/04; H01Q 5/00; H01Q 1/24

(52) U.S. Cl. 343/702; 343/700 MS

(57) ABSTRACT

An antenna system internal to the device especially intended for small-sized mobile stations, the system having separate operating bands. The system is implemented as decentralized in a way that the device (300) has a plurality of separate antennas (310-360). Each antenna is based on (a) radiating element(s) on the surface of a dielectric substrate. The substrate can be, for example, a piece of ceramics or a part of the outer casing of the device. The antennas are located at suitable places in the device. The operating band of an individual antenna covers the frequency range used by one radio system, the frequency ranges close to each other and is used by two different radio systems or only the transmitting or receiving band of the frequency range used by a radio system. If the device has a shared transmitter and a shared receiver for the radio systems using frequency ranges close to each other, there can anyway be a separate antenna for each system or the antenna can also be shared. The antennas can be made very small, because a relatively small bandwidth is sufficient for an individual antenna, when there is a plurality of antennas. A good matching of the antenna is achieved on the whole width of each radio system, because the matching of a separate antenna having a relatively narrow band is easier to arrange than that of a combined multi-band antenna. No switches are needed in the structure for choosing a sub-band, which contributes to good efficiency for its part.

The invention relates to an internal antenna system of a radio device with separate operating bands. The system is intended for use especially in small-sized mobile stations.

In small-sized, mobile radio devices the antenna is preferably placed inside the casing of the device for convenience. This makes the design of the antenna a more demanding task compared to an external antenna. Extra difficulties in the design are caused when the radio device has to function in a plurality of frequency ranges, the more the wider these ranges or one of them are.

Internal antennas most often have a planar structure, in which case they have a radiating plane and a parallel ground plane at a certain distance from it. The radiating plane is provided with a short-circuit and feed point of the antenna. The short-circuit conductor belonging to the structure extends from the short-circuit point to the ground plane, and the feed conductor of the antenna extends from the feed point to the antenna port of the device. For increasing the number of operating bands of the antenna, the radiating plane can be divided into two or more branches of different length as seen from the short-circuit point. The number of bands can also be increased by a parasitic auxiliary element. As an alternative, a parasitic element can be used for widening an operating band by arranging the resonance frequency corresponding to it relatively close to the resonance frequency corresponding to a branch of the radiating plane.

In this description and the claims, the terms “radiating plane”, “radiating element” and “radiator” mean an antenna element, which can function as a part transmitting radio-frequency electromagnetic waves, as a part receiving them or as a part which both transmits and receives them. Correspondingly, “feed conductor” means a conductor which can also function as a receiving conductor.

The antennas of the kind described above have the drawback that their characteristics are insufficient when the number of radio systems in accordance with which the radio device must function increases. The insufficiency appears from that e.g. the matching of the antenna is poor in the band used by one of the radio systems or in a part of at least one of such bands. This drawback can be diminished by providing the antenna structure with a switch by which the operating band of a relatively narrow-band antenna can be displaced from the transmitting band of the radio system to the receiving band and vice versa or to a sub-band within the transmitting or receiving band. However, the switch causes additional losses and thus reduces the efficiency of the antenna. The efficiency of the antenna can thus remain unsatisfactory because of poor matching or switch losses, for example. Said drawbacks are emphasized when the antenna size has to be compromised because of the lack of space. The size is reduced by shortening the distance between the radiating plane and the ground plane or by using dielectric material between them, for example. In addition, these antennas have the drawback that it is difficult to make sufficient isolation between the antenna parts corresponding to different bands.

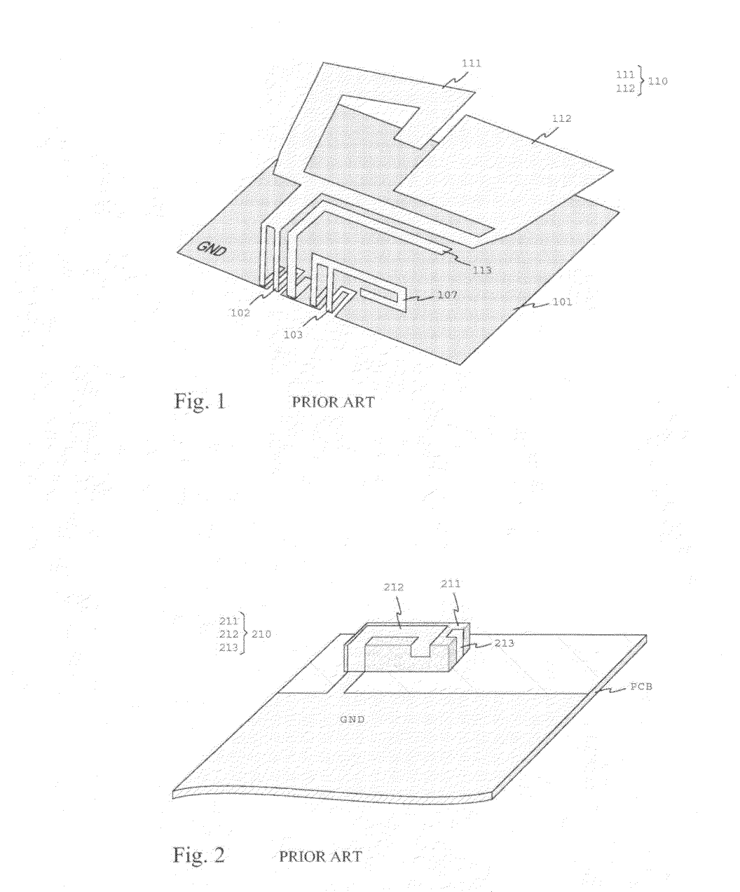

It is also possible to arrange two radiators in the antenna structure so that they both have a feed conductor of their own. This can be done when the radio device has a separate transmitter and receiver for some radio system. FIG. 1 shows an example of such an antenna structure known from the publication WO 02/078123. It comprises a ground plane 101, a radiating plane 110, a parasitic element 113 of the radiating plane and a segregated radiator 107. The radiating plane has a feed conductor 102 and a short-circuit conductor, and thus it forms a PIFA (Planar Inverted F-Antenna) together with the ground plane. The PIFA has two bands, because the radiating plane is divided into a first 111 and a second 112 branch as seen from the short-circuit and feed point. The first branch functions as a radiator in the frequency range of the GSM900 (Global System for Mobile communications) system and the second branch in the range of the DCS (Digital Cellular Standard) system. The parasitic element 113 is connected to the ground plane and it functions as a radiator in the range of the PCS (Personal Communication Service) system. The segregated radiator 107 has its own feed conductor 103 and short-circuit conductor. Together with the ground plane it forms an IFA, which functions as a Bluetooth antenna. The segregated radiator is located near the radiating plane and its parasitic element so that the short-circuit and feed conductors of the radiating plane, the short-circuit conductor of the parasitic element and the short-circuit and feed conductors of the segregated radiator are in a row in a relatively small area compared to the dimensions of the antenna structure. The support structure of the antenna elements is not visible in the drawing.

The segregated radiator mentioned above, provided with its own feed, is thus for the Bluetooth system. Such a radiator can similarly be e.g. for the WCDMA (Wideband Code Division Multiple Access) system. In general, the use of a segregated radiator provided with its own feed reduces the drawbacks mentioned above to such an extent that the matching can be made good at least in the frequency range of the radio system for which the segregated radiator is provided.

The use of dielectric material for reducing the physical size of the antenna was mentioned above. FIG. 2 shows an example of such a known antenna. This comprises a dielectric substrate 211, a radiator 212 and its feed element 213. The radiator and the feed element are conductor strips on the surface of the substrate. All three together form an antenna component, which is mounted on the circuit board PCB of a radio device.

The object of the invention is to reduce the above-mentioned drawbacks of the prior art. The arrangement according to the invention is characterized in what is set forth in the independent claim 1. Some preferred embodiments of the invention are set forth in the other claims.

The basic idea of the invention is the following: The antenna system of a multiband radio device is implemented as internal and decentralized in a way that the device has a plurality of separate antennas. Each antenna is based on (a) radiating elements) on the surface of a dielectric substrate. The substrate can be, for example, a piece of ceramics or a part of the outer casing of the device. The antennas are located at suitable places in the device. The operating band of an individual antenna covers the frequency range used by one radio system, the frequency ranges close to each other and used by two different radio systems or only the transmitting or receiving band of the frequency range used by a radio system. If the device has a shared transmitter and a shared receiver for the radio systems using frequency ranges close to each other, there can anyway be a separate antenna for each system or the antenna can also be shared.

The invention has the advantage that the size of the antennas can be made small. This is due to that when there is a plurality of antennas, a relatively small bandwidth is sufficient for an individual antenna. When the bandwidth is small, a material with higher permittivity can be chosen for the antenna than for an antenna having a wider band, in which case the antenna dimensions can be made correspondingly smaller. In addition, the invention has the advantage that a good matching is achieved on the whole width of the band of each radio system. This is due to that the matching of a separate antenna having a relatively narrow band is easier to arrange than the matching of a combined multiband antenna. The invention further has the advantage that the antenna system has a good efficiency in different bands. This is partly due to the quality of the matching and partly to that no switches for choosing a sub-band are needed in the structure. Both the matching and the efficiency are also improved by the fact that in a decentralized system the antennas can each be located in a place which is advantageous with regard to its function. The invention further has the advantage that the isolation between the antennas is good. This is due to the sensible decentralization of the antennas and the fact that a substrate with a relatively high permittivity collapses the near field of the antenna.

In the following, the invention will be described in detail. Reference will be made to the accompanying drawings, in which

FIG. 1 shows an example of a known multiband antenna,

FIG. 2 shows an example of a known antenna component using a dielectric substrate,

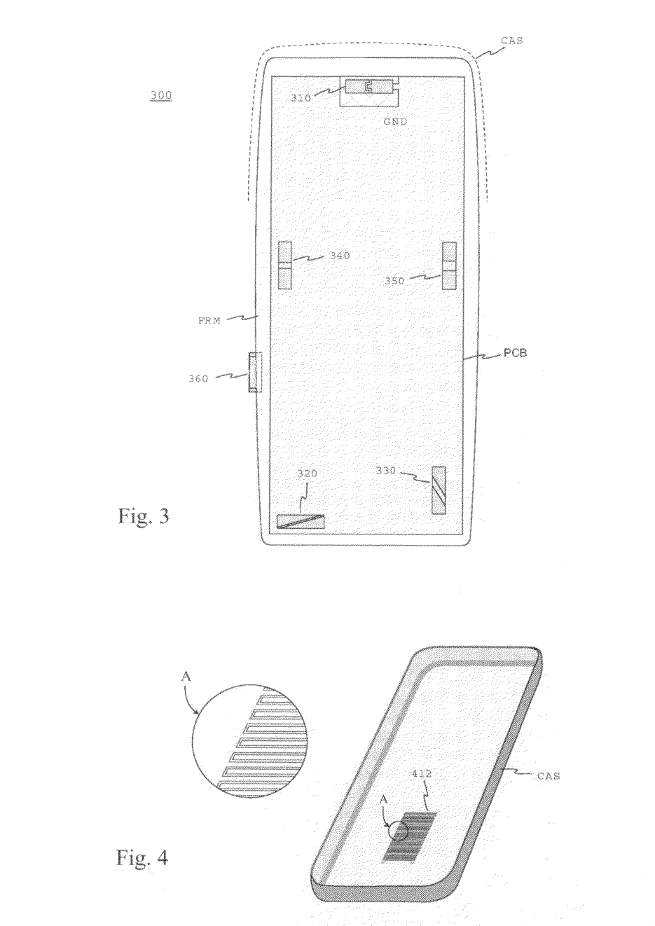

FIG. 3 shows an example of the placement of the antennas in an antenna system according to the invention,

FIG. 4 shows another example of the placement of an antenna belonging to the antenna system according to the invention,

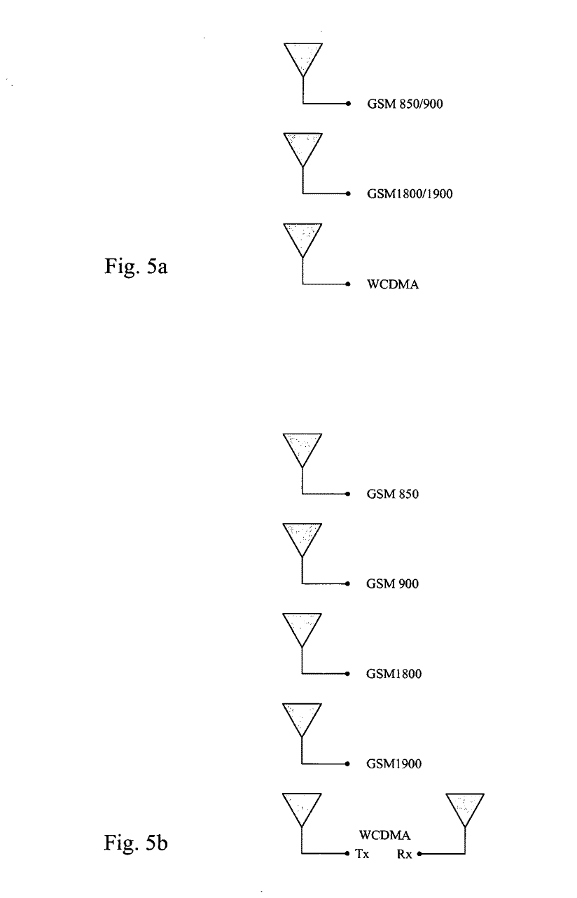

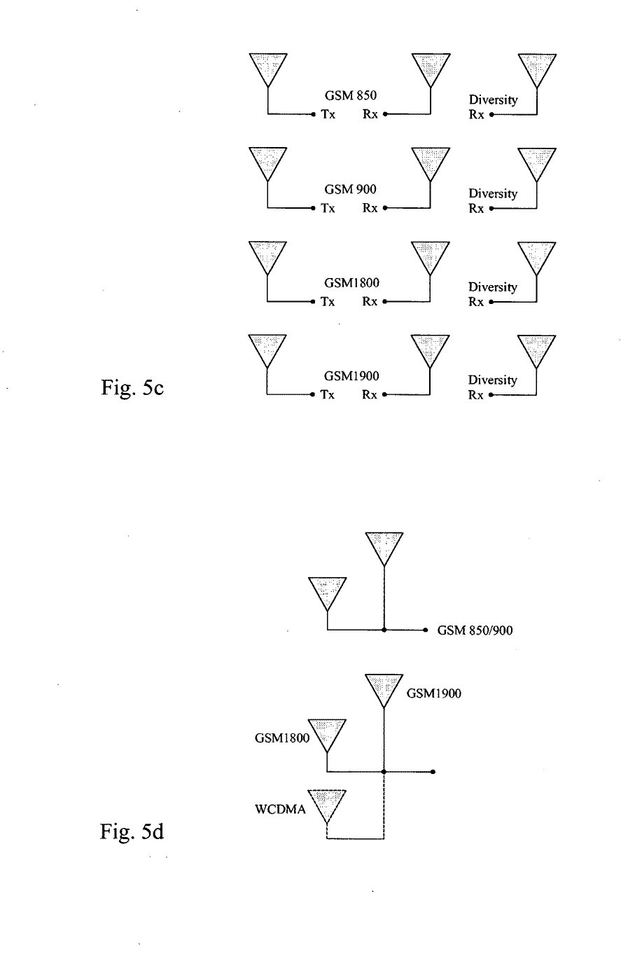

FIGS. 5a-d show examples of the composition of an antenna system according to the invention,

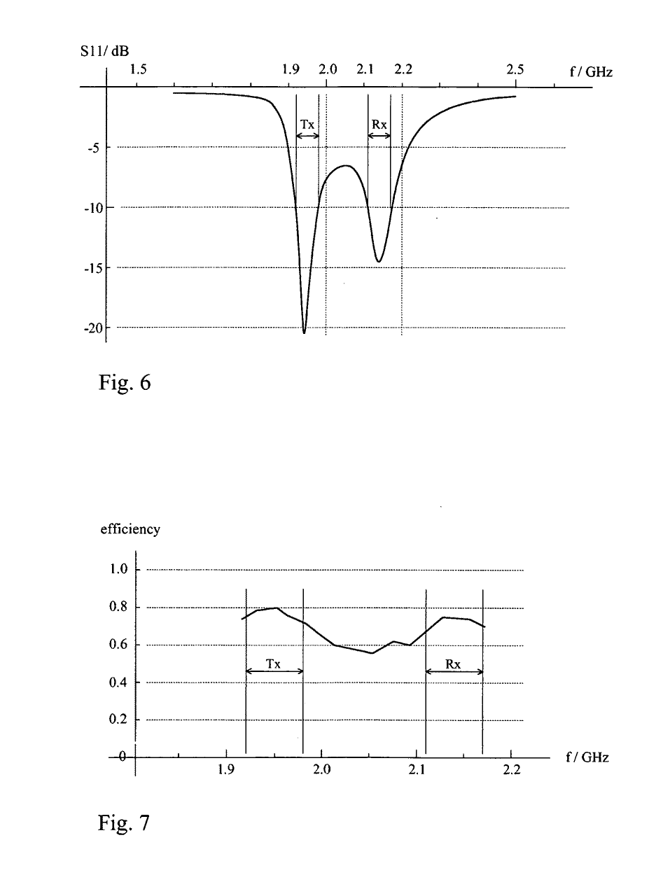

FIG. 6 shows an example of the matching of a pair of antennas in an antenna system according to FIG. 3, and

FIG. 7 shows an example of the efficiency of a pair of antennas in an antenna system according to FIG. 3.

FIGS. 1 and 2 were already described in connection with the prior art.

FIG. 3 shows an example of an antenna system according to the invention as a layout drawing. There is a radio device 300 with a circuit board PCB, plastic frame FRM and casing CAS in the drawing. A large part of the surface of the circuit board on the side visible in the drawing consists of a conductive ground plane GND. In this example the antenna system includes six antennas. Each one of these comprises an elongated antenna component with a ceramic substrate and two radiating elements. The ground plane around the antenna component is also considered to be a part of the antenna here. In this example, the radiating elements of each antenna component are of the same size so that they resonate in the same, relatively narrow frequency range. The feed conductor of an antenna is connected to one element, and the other element is parasitic.

The first 310, the second 320, the third 330, the fourth 340 and the fifth 350 antenna component are mounted on the same side of the circuit board PCB, visible in the drawing. The first antenna component 310 is located in the middle of the first end of the circuit board, parallel with the end. The second antenna component 320 is located in a corner defined by the second end and the first long side of the circuit board, parallel with the end. The third antenna component 330 is located near the corner defined by the second end and the second long side of the circuit board, parallel with the long side. The fourth antenna component 340 is located beside the first long side of the circuit board parallel with it, slightly closer to the first than the second end. The fifth antenna component 350 is located beside the second long side of the circuit board parallel with it, opposite to the fourth antenna component. The sixth antenna component 360 is mounted on the side surface of the frame FRM, which surface is perpendicular to the plane of the circuit board. The antenna components are located at places which are advantageous with regard to the other RF parts and so that they do not much interfere with each other.

FIG. 3 also shows an example of the ground arrangement of the antennas. The ground plane of the surface of the circuit board has been removed from below and beside the first antenna component 310 to a certain distance. However, a narrow part of the ground plane extends to one or more points of the radiators. Such an arrangement increases the electric size of the antenna compared to that the ground plane would continue as wide to the area under the component. In that case e.g. the height of an antenna component operating in a certain frequency range can be correspondingly reduced. The other antennas can have a similar ground arrangement. In theory, the whole ground plane is naturally shared between all the antennas. In practice, the system has mainly antenna-dedicated ground planes, because of the decentralization of the antenna components. This becomes evident from the fact that the distance along the ground plane between two radiators belonging to different antennas is at least the combined length of these radiators.

The antennas according to FIG. 3 can be designed e.g. as follows:
the antenna based on the component 310 is an antenna for the GSM850 system;
the antenna based on the component 320 is an antenna for the GSM900 system;
the antenna based on the component 330 is an antenna for the GSM1800 system;
the antenna based on the component 340 is a transmitting antenna for the WCDMA system;
the antenna based on the component 350 is a receiving antenna for the WCDMA system;
the antenna based on the component 360 is an antenna for the GSM1900 system.

FIG. 4 shows another example of the placement of an antenna belonging to the antenna system according to the invention. The rear portion CAS of the outer casing of a radio device and a radiator 412 on its inner surface are seen in the drawing. In this example the radiator is a dense meander pattern by shape, and it has been implemented by growing conductor material on the surface of the casing. Thus the part of the casing under the radiator functions as the substrate belonging to the antenna.

FIGS. 5a-5d show examples of the composition of the antenna system according to the invention as schematic diagrams. In FIG. 5a there are three antennas. One of them is shared between the GSM850 and GSM900 systems, the second is shared between the GSM1800 and GSM1900 systems, and the third is for the WCDMA system. In FIG. 5b, there are six antennas for the same bands as above in the example mentioned in the description of FIG. 3. So, one of them is for the GSM850 system, the second for the GSM900, the third for the GSM1800, the fourth for the GSM1900, the fifth for the transmitting side of the WCDMA system, and the sixth for the receiving side of the WCDMA system, listed in the order of FIG. 5b. In FIG. 5c there are twelve antennas. One of them is for the transmitting side of the GSM850 system, and the second and the third for the receiving side of the GSM850 system. The latter two are used to implement the space diversity in the receiving. There is a corresponding group of three antennas for the GSM900, GSM1800 and GSM1900 system as well. FIG. 5d presents a modification of the composition according to FIG. 5a. Now the all four GSM systems have their own antenna. However, the GSM850 and GSM900 antennas, the operating bands of which are close to each other, are connected to the same feed line. After the separation of the transfer directions, the antennas then become connected to the shared transmitter and the shared receiver of these systems. In the same way the GSM1800 and GSM1900 antennas, the operating bands of which are close to each other, are connected to a shared feed line. The WCDMA antenna can also be connected to this line.

FIG. 6 presents an example of the matching of the antenna system according to FIG. 3 for the antennas corresponding to the fourth 340 and the fifth 350 antenna component, when these are designed to function as the transmitting and receiving antennas of the WCDMA system. The substrate of the antenna components is of a ceramics, and its dimensions are 10·3·2 mm³ (length, width, height). The FIG. shows the curve of the reflection coefficient S11 as a function of frequency. It is seen from the curve that the reflection coefficient is −10 dB or better in the range of both the transmitting and the receiving band. The matching of the antenna pair is then good.

FIG. 7 shows a curve of the efficiency of the same antenna pair to which FIG. 6 applies as a function of frequency. It is seen that the efficiency is approx. 0.76 on the average in the transmitting band and approx. 0.72 in the receiving band. The efficiency of the antenna pair is thus excellent considering the small size of the antenna components. The maximum gain of the transmitting antenna is approx. 1.3 dB and the maximum gain of the receiving antenna approx. 2.3 dB on an average as measured in free space

A decentralized antenna system according to the invention has been described above. As appears from the examples described, the number and the location of the antennas can vary greatly. The invention does not limit the method of manufacture of individual antenna components. The manufacture can take place for example by coating a piece of ceramics partly with conductive material or by growing a metal layer on the surface of e.g. silicon and removing a part of it by the technique used in the manufacture of semiconductor components. The inventive idea can be applied in different ways within the scope defined by the independent claim 1.

1-9. (canceled)

10. An internal antenna system of a radio device, comprising:
a ground plane; and
at least two antenna components, each of said antenna components comprising at least one radiating element;
wherein said ground plane comprises a dimension, said ground plane dimension being equal to at least a combined length of said radiating elements; and
wherein said ground plane and said at least two radiating elements form at least two substantially separate operating bands.

11. The antenna system of claim 10, wherein each of said radiating elements comprises:
a conductor; and
a dielectric substrate;
wherein said conductor is disposed on said dielectric substrate.

12. The antenna system of claim 11, wherein said radiating elements are substantially similar in size so as to resonate within a substantially similar and narrow frequency range.

13. The antenna system of claim 11, wherein at least one of said antenna components is located on a circuit board of said radio device.

14. The antenna system of claim 11, wherein at least one of said antenna components is disposed on a surface of an internal frame of said radio device.

15. The antenna system of claim 10, wherein at least one of said operating bands comprises a frequency range used by at least one radio system.

16. The antenna system of claim 10, wherein said operating bands comprise frequency ranges used by at least two separate systems.

17. The antenna system of claim 15, wherein at least one of said operating bands comprises a transmitting band in a frequency range used by a radio system, and at least one of said operating bands comprises a receiving band of the same frequency range.

18. The antenna system of claim 15, wherein at least one of said operating bands comprises the receiving band in a frequency range used by said radio system to implement spatial diversity for at least a received signal.

19. The antenna system of claim 11, wherein said substrate comprises a ceramic.

20. The antenna system of claim 11, wherein said substrate is disposed at least partly on an outer casing of said radio device.

21. An internal antenna system of a radio device, comprising:
a circuit board comprising a conductive surface and further comprising a ground plane;
a frame, said frame surrounding at least a portion of said circuit board;
a casing disposed at least partly about said circuit board and said frame; and
a plurality of antennas, each of said antennas comprising at least two radiating elements;
wherein said ground plane and said radiating elements form at least two separate operating bands.

22. The antenna system of claim 21, said plurality of antennas comprising:
a first antenna disposed substantially centered at a first end of said circuit board;
a second antenna disposed proximate a first corner of said circuit board; and
a third antenna disposed proximate a second corner of said circuit board, and perpendicular in orientation with respect to said second antenna.

23. The antenna system of claim 22, said plurality of antennas further comprising:
a fourth antenna disposed proximate to a first long side of said circuit board;
a fifth antenna disposed proximate a second long side of said circuit board, and substantially parallel to said fourth antenna; and
a sixth antenna disposed on a surface of said frame.

24. The antenna system of claim 21, wherein said ground plane comprises a first distance, said first distance being equal to at least a combined length of said radiating elements.

25. The antenna system of claim 21, wherein said radiating elements comprise:
a conductor; and
a dielectric substrate;
wherein said conductor is disposed on said dielectric substrate.

26. The antenna system of claim 25, wherein said substrate comprises a ceramic substrate.

27. The antenna system of claim 25, wherein said radiating elements are substantially similar in size so as to resonate within a substantially similar frequency range.

28. The antenna system of claim 21, wherein said casing further comprises a conductive material, said casing further being adapted to function as a substrate of said antenna system.

29. The antenna system of claim 21, wherein at least one of said operating bands includes a frequency range used by at least one radio system.

30. The antenna system of claim 21, wherein said operating bands comprise frequency ranges used by at least two separate systems.

31. The antenna system of claim 30, wherein at least one of said operating bands comprises a transmitting band in the frequency range used by a radio system, and at least one of said operating bands comprises a receiving band of the same frequency range.

32. The antenna system of claim 30, wherein at least one of said operating bands comprises the receiving band in the frequency range used by said radio system to implement a spatial diversity plan.

33. A method of operating an internal antenna system, said system comprising at least two antennas, said method comprising:
operating said antenna system in a first state, said first state comprising utilizing a first one of said at least two antennas, said first antenna comprising at least two operating bands; switching said state of said antenna system; and
operating said antenna system in a second state, said second state comprising utilizing a second one of said at least two antennas, said second antenna component comprising at least two operating bands;
wherein said at least two operating bands of said second antenna are different than said at least two operating bands of said first antenna.

34. The method of claim 33, wherein said antenna system comprises at least one operating band for a GSM 850 system.

35. The method of claim 33, wherein said antenna system comprises at least one operating band for a GSM 900 system.

36. The method of claim 33, wherein said antenna system comprises at least one operating band for a GSM 1800 system.

37. The method of claim 33, wherein said antenna system comprises at least one operating band for a WCDMA system.

38. The method of claim 33, wherein said antenna system comprises three antennas, said first antenna comprising at least one operating band for a GSM 850 system and for a GSM 900 system, said second antenna comprising at least one operating band for a GSM 1800 system and for a GSM 1900 system, and said third antenna comprising at least one operating band for the WCDMA system.

39. An internal antenna system of a radio device, comprising a ground plane and at least two radiating elements to form at least two separate operating bands, which cover the frequency ranges used by at least two different systems characterized in that each radiating element is a conductor on a surface of a dielectric substrate;
the radiating elements form together with the substrates and said ground plane at least two separate antennas, which have different operating bands, and
a distance along said ground plane between two radiators belonging to different antennas is at least the combined length of these radiators.

40. An antenna system according to claim 39, characterized in that the substrate of an individual antenna and the at least one radiating element on the surface of the substrate constitute a unitary, chip-type antenna component.

41. An antenna system according to claim 40, characterized in that at least one of the antenna components is located on a circuit board of the radio device.

42. An antenna system according to claim 40, characterized in that at least one of the antenna components is on a surface of an internal frame of the radio device.

43. An antenna system according to claim 39, characterized in that an operating band of an antenna belonging to the antenna system covers a frequency range used by at least one radio system.

44. An antenna system according to claim 39, characterized in that an operating band of an antenna belonging to the antenna system covers a transmitting band in the frequency range used by a radio system, and an operating band of another antenna belonging to the antenna system covers a receiving band of the same frequency range.

45. An antenna system according to claim 44, characterized in that it further comprises an antenna, an operating band of which likewise covers the receiving band in the frequency range used by the radio system in question to implement the space diversity in the receiving.

46. An antenna system according to claim 40, characterized in that said substrate is of a ceramics.

47. An antenna system according to claim 39, characterized in that the substrate of an individual antenna is a part of an outer casing of the radio device.

48. A multiband antenna system, comprising:
at least one dielectric substrate;
a ground plane; and
a plurality of radiating elements disposed at least partly on said at least one substrate, said plurality of radiating elements being disposed substantially distant from one another so as to produce substantially dedicated ground planes within said ground plane for respective ones of said radiating elements.

49. The antenna system of claim 48, wherein said at least one substrate comprises a part of the outer casing of a mobile communications device.

50. A multiband antenna system, comprising:
at least one dielectric substrate; and
a plurality of high permittivity, low-bandwidth radiating elements disposed at least partly on said at least one substrate, the number of said plurality being sufficient so as to permit a size of each of said radiating elements to be smaller than that necessary if a smaller number were utilized.

51. A matched multiband antenna system having a plurality of radio frequency bands associated therewith, the system comprising:
at least one dielectric substrate; and
a plurality of substantially discrete low frequency bandwidth radiating elements disposed at least partly on said at least one substrate;
wherein use of said plurality of substantially discrete low bandwidth radiating elements allows for said matching.
